(19) United States
(12) Patent Application Publication
(10) Pub. No.: US 2025/0356176 A1
(43) Pub. Date: Nov. 20, 2025

(54) QUANTIZED FEDERATED LEARNING

(71) Applicant: Nokia Technologies Oy, Espoo (FI)

(72) Inventors: Tejas SUBRAMANYA, Munich (DE); Abdelrahman ABDELKADER, Munich (DE); Alberto CONTE, Massy (FR)

(21) Appl. No.: 18/874,269

(22) PCT Filed: Jun. 27, 2022
(86) PCT No.: PCT/EP2022/067516

§ 371 Date: Dec. 12, 2024

(51) Int. Cl. G06N 3/0495; G06N 3/098

(52) U.S. Cl. CPC G06N 3/0495; G06N 3/098

(57) ABSTRACT

Method, comprising: receiving an indication of one or more supported bit-widths for local learning by a first node among plural nodes; generating a respective quantized version of a model for at least one of the supported bit-widths; providing the generated respective quantized versions of the model for the at least one of the supported bit-widths or a link to location from where the first node may download the at least one quantized version of the model for the at least one of the supported bit-widths to the first node.

### FIELD OF THE INVENTION

The present disclosure relates to federated learning.

### ABBREVIATIONS

3GPP 3rd Generation Partnership Project
5G/6G/7G 5^{th}/6^{th}/7^{th} Generation
5GC 5G Core network
ADRF Analytical Data Repository Function
AI Artificial Intelligence
BTS Base Transceiver Station
CPU Central Processing Unit
E2E End-to-end
FL Federated Learning
FP Floating Point
gNB gNodeB (5G base station)
HW Hardware
ID Identifier
INT Integer
IOC Information Object Class
ML Machine Learning
NWDAF Network Data Analytics Function
UE User Equipment

### BACKGROUND

Many applications (e.g. in mobile networks) require a large amount of data from multiple distributed sources like UEs or distributed gNBs to be used to train a single common model. To minimize the data exchange between the distributed units from where the data is generated and the centralized unit(s) where the common model need to be created, the concept of Federated learning (FL) may be applied. FL is a form of machine learning where, instead of model training at a single node, different versions of the model are trained at the different distributed hosts. This is different from distributed machine learning, where a single ML model is trained at distributed nodes to use computation power of different nodes. In other words, FL is different from distributed learning in the sense that: 1) each distributed node in a FL scenario has its own local training data which may not come from the same distribution as the local training data at other nodes; 2) each node computes parameters for its local ML model and 3) the central host (aggregating unit, aggregator) does not compute a version or part of the model but combines parameters of all the distributed models to generate a main model (aggregated model). The objective of this approach is to keep the training dataset where it is generated and perform the model training locally at each individual learner in the federation.

After training a local model, each individual learner transfers its local model parameters, instead of the (raw) training dataset, to an aggregating unit (aggregator). The aggregating unit utilizes the local model parameters to update a global model which may eventually be fed back to the local learners for further iterations until the global model converges. As a result, each local learner benefits from the datasets of the other local learners only through the global model, shared by the aggregator, without explicitly accessing high volume of (potentially privacy-sensitive) data available at each of the other local learners. For example, UEs may serve as local learners and a gNB may function as an aggregator. The local models (from UEs to gNB) and the aggregated model (from gNB to UEs) are both transmitted on regular communication links between the gNB and the UEs.

Summarizing, FL training process can be explained by the following main steps:
Initialization: A machine learning model (e.g., linear regression, neural network) is chosen to be trained on local nodes and initialized.
Client selection: a fraction of local nodes is selected to start training on local data. The selected nodes acquire the current statistical model while the others wait for the next federated round.
Reporting and Aggregation: each selected node sends its local model to the central function (may be hosted by a central server) for aggregation. The central function aggregates the received models and sends back the model updates to the nodes.
Termination: once a pre-defined termination criterion is met (e.g., a maximum number of iterations is reached), the central function aggregates the updates and finalizes the global model.

FIG. 1 shows an example of FL training. Each training iteration comprises training device selection, model distribution & training configuration, and training result reporting. In the example of FIG. 1, there is an FL aggregator 400 (e.g. gNB), and the local nodes are UE1 to UE3 (402, 404, 406). In detail:

In 401, the aggregator 400 requests each node to provide its configuration. The UEs 402, 404, 406 provide their configurations in 403, 405, and 407.

In 409, the aggregator selects UE1 and UE3 for the next iteration 451 of the federated learning. Accordingly, in 411 and 413, the aggregator provides the model and training configuration to UE1 and UE3.

UE1 and UE3 perform the FL local training in 415 and 417, and provide their training results to the aggregator 400 in 419 and 421. The aggregator 400 performs the aggregation in 423.

These actions are correspondingly repeated for the next iteration 491, where UE2 and UE3 are selected.

After several local training and update exchanges between the FL aggregator and its associated distributed nodes, a globally optimal learning model may be achieved.

Quantization refers to techniques for performing computations and storing tensors at lower bit-widths than floating point precision. A quantized model executes some or all of the operations on tensors with integers rather than with floating point values. This allows for a more compact model representation and the use of high performance vectorized operations on many hardware platforms. For example, compared to typical FP32 models, INT8 quantization allows for a 4x reduction in the model size and a 4× reduction in memory bandwidth requirements. Hardware support for INT8 computations is typically 2 to 4 times faster compared to FP32computations. Quantization is primarily a technique to speed up inference. Adaptation to execution hardware is another reason to perform quantization, for example when embedding models on specialized hardware (e.g. a drone, an AI-dedicated HW-accelerator in a BTS . . . ).

A floating-point number is represented approximately with a fixed number of significant digits (the significand) and scaled using an exponent in some fixed base; the base for the scaling is typically two, ten, or sixteen. In contrast, an integer number is represented directly by the respective number of bits.

There exist several techniques to quantizing a deep learning model, that can be roughly classified into:
Post-training quantization: model is trained in FP32 and then, the model is converted into a lower bit-width, e.g. INT8, with little degradation in model accuracy. A typical Scenario is as follows: A ML model is trained and stored to be used. A consumer identifies the need for the model but it is unable to run the model due to lack of compatibility between the consumer bit-widths and the model's bit-width. In that case the model is converted into a compatible bit-width.
Quantization-aware training: which perform quantization during training, by forcing (or faking) quantized values in tensors and parameters. Several techniques are possible. By taking into account quantization-errors during training, quantization- aware training is known to achieve in general better accuracy than post-training quantization. A typical scenario is as follows: A consumer identifies the need for a ML model but it is UNTRAINED. The consumer has limitations on what type of applications can run on it's software/hardware capabilities (e.g. bit-width) The producer triggers the training of the required model in a “quantized way” as stated in the text to provide the Quantized trained ML model to the consumer according to it's needs.

A digital HW (like a CPU) will always operate with a finite number of digits. Therefore, for the purpose of the present application, quantization refers to techniques for performing computations and storing tensors at lower bit-widths than floating point precision.

The MLModel data type includes the attributes inherited from TOP IOC (defined in 3GPP TS 28.622) as well as those as defined in PCT/EP2021/059631. According to PCT/EP2021/059631, each training context, expected context or detected context may comprise one or more of the following context attributes: a managed entity reference attribute, a data provider reference attribute, a start time attribute, an end time attribute, a training conditions 10 attribute, a training state attribute, an operating conditions attribute, a reference performance attribute, a cognitive network function properties attribute and/or a data characteristics attribute. The cognitive network function information object class may comprise a cognitive network function properties attribute with a plurality of fields, each field having a single value selected among a fixed set of alternatives. The machine learning model information object class may comprise a training context attribute, an expected context attribute and/or a detected context attribute with a plurality of fields, each field having a single value selected among a fixed set of alternatives. The MLModel data type represents the properties of an MLModel.

### SUMMARY

It is an object of the present invention to improve the prior art.

According to a first aspect of the invention, there is provided an apparatus comprising:
one or more processors and memory storing instructions that, when executed by the one or more processors, cause the apparatus to perform:
receiving an indication of one or more supported bit-widths for local learning by a first node among plural nodes;
generating a respective quantized version of a model for at least one of the supported bit-widths;
providing the generated respective quantized versions of the model for the at least one of the supported bit-widths or a link to location from where the first node may download the at least one quantized version of the model for the at least one of the supported bit-widths to the first node.

According to a second aspect of the invention, there is provided an apparatus comprising:
one or more processors, and memory storing instructions that, when executed by the one or more processors, cause the apparatus to perform:
determining one or more supported bit-widths supported by a first node for local learning;
providing, to an aggregator, an indication of the one or more supported bit-widths;
receiving a quantized version of a model, wherein the quantized version of the model is quantized with one of the supported bit-widths;
performing the local learning on the quantized version of the model to obtain a set of quantized parameters of the model;
transmitting the set of quantized parameters of the model to the aggregator when the local learning is finalized.

According to a third aspect of the invention, there is provided a method comprising:
receiving an indication of one or more supported bit-widths for local learning by a first node among plural nodes;
generating a respective quantized version of a model for at least one of the supported bit-widths;
providing the generated respective quantized versions of the model for the at least one of the supported bit-widths or a link to location from where the first node may download the at least one quantized version of the model for the at least one of the supported bit-widths to the first node.

According to a fourth aspect of the invention, there is provided a method comprising:
determining one or more supported bit-widths supported by a first node for local learning;
providing, to an aggregator, an indication of the one or more supported bit-widths;
receiving a quantized version of a model, wherein the quantized version of the model is quantized with one of the supported bit-widths;
performing the local learning on the quantized version of the model to obtain a set of quantized parameters of the model;
transmitting the set of quantized parameters of the model to the aggregator when the local learning is finalized.

Each of the methods of the third and fourth aspects may be a method of federated learning.

According to a fifth aspect of the invention, there is provided a computer program product comprising a set of instructions which, when executed on an apparatus, is configured to cause the apparatus to carry out the method according to any of the third and fourth aspects. The computer program product may be embodied as a computer readable medium or directly loadable into a computer.

According to some example embodiments of the invention, at least one of the following advantages may be achieved:
all distributed nodes may finalize the local learning in time (prior to the reporting time).
Unfairness among the distributed nodes may be reduced or avoided.

It is to be understood that any of the above modifications can be applied singly or in combination to the respective aspects to which they refer, unless they are explicitly stated as excluding alternatives.

### BRIEF DESCRIPTION OF THE DRAWINGS

Further details, features, objects, and advantages are apparent from the following detailed description of the preferred embodiments of the present invention which is to be taken in conjunction with the appended drawings, wherein:

FIG. 1 illustrates federated learning;

FIG. 2 illustrates a message sequence chart according to some example embodiments of the invention;

FIG. 3 shows an apparatus according to an example embodiment of the invention;

FIG. 4 shows a method according to an example embodiment of the invention;

FIG. 5 shows an apparatus according to an example embodiment of the invention;

FIG. 6 shows a method according to an example embodiment of the invention; and

FIG. 7 shows an apparatus according to an example embodiment of the invention.

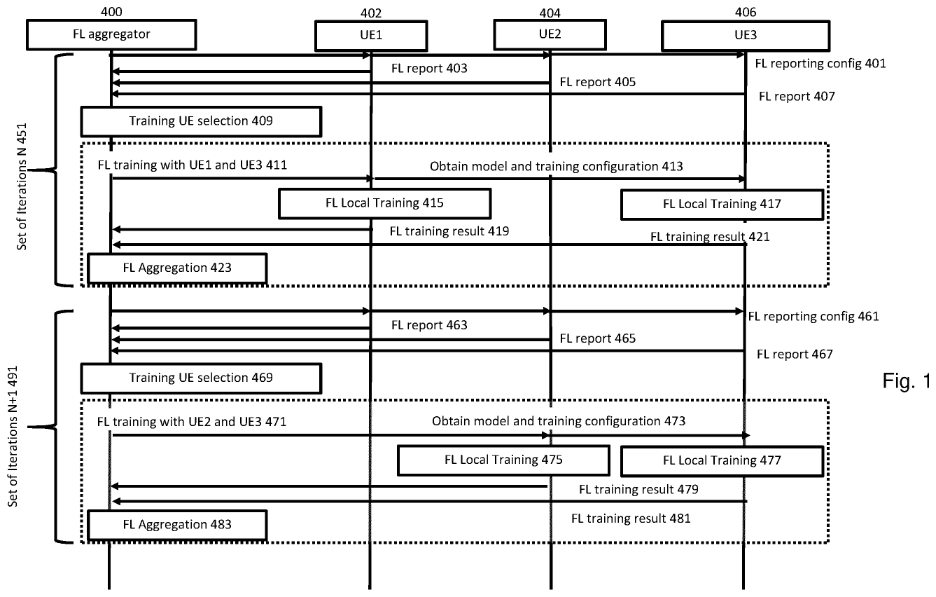

### DETAILED DESCRIPTION OF CERTAIN EMBODIMENTS

Herein below, certain embodiments of the present invention are described in detail with reference to the accompanying drawings, wherein the features of the embodiments can be freely combined with each other unless otherwise described. However, it is to be expressly understood that the description of certain embodiments is given by way of example only, and that it is by no way intended to be understood as limiting the invention to the disclosed details.

Moreover, it is to be understood that the apparatus is configured to perform the corresponding method, although in some cases only the apparatus or only the method are described.

In Federated Learning, for each (or several) iteration(s) of the training process, the FL Aggregator (located, for example, in an Application Function or as a standalone function in the 5GC) selects the training UEs that can participate in the local training process. The selection of training UEs is either random or based on various criteria such as computational resource availability in the UEs, power availability in the UEs, (fresh/new) training data availability in the UE, communication link quality to the UEs, etc. The UE may report the value of these criteria within the training resource report. The selected training UEs may require a significant amount of time (e.g., hours, days) to perform local training which varies for each training UE depending on the ‘bit-widths’ supported by different training UEs. Consequently, for each iteration, the FL Aggregator typically has to wait for a significant amount of time until it receives local model parameters from all training UEs (with different supported bit-widths) participating in the FL training process, which is not ideal. As one option, if some training UEs (with low bit-width capability) do not/cannot report their local model parameters before the reporting deadline, they will not be considered for FL aggregation in that particular iteration. This omission may lead to unfairness towards those training UEs.

A major factor contributing to different training times in FL is the device heterogeneity (i.e., bit- width) of the training UEs participating in the FL training process. This heterogeneity indirectly leads to a certain level of unfairness towards training UEs supporting only lower bit-width capabilities. Some example embodiments of the invention may minimize the waiting time of the FL Aggregator to receive local model updates from all training UEs participating in the FL training process and subsequently reduce the overall training time required in FL.

According to some example embodiments of the invention:
(1) For each (or at least one) iteration(s) of the FL training process, the training UEs may report on their supported bit-widths capability to the FL Aggregator.
(2) The FL Aggregator may maintain a mapping table of training UEs mapped to their supported bit-widths. Based on the mapping table, for each (or at least one) iteration(s), the FL Aggregator decides on the customized quantization (e.g., 8-bit integers, 16-bit integers) to be applied on the (floating-point) aggregated model parameters (i.e., global model) for each training UE, to ensure that each of the training UEs can meet the reporting deadline to report their local model parameters.
(3) The FL Aggregator may generate, from the global model, a quantized model (“custom quantized” global model) for each of the decided quantizations. Once the global model is custom quantized for one of the training UEs, the FL Aggregator sends the quantized global model to the corresponding training UE.
   a) In some example embodiments, multiple custom quantized global models may be sent to at least one of the training UEs participating in the FL and each of the training UEs decides by itself which quantized model to be used for a particular iteration.
   b) In some example embodiments, the FL Aggregator sends a list of custom quantized global model descriptors, along with their downloadable location information, to each training UE allowing them to download their preferred model for a particular iteration of FL training.
(4) The training UEs perform local training using the received custom quantized model.
(5) Once the local training is complete, the training UEs will send their (quantized) local model parameters to the FL Aggregator adhering to the reporting deadline.
(6) The FL Aggregator may de-quantize the local model parameters received from each training UE to the floating-point format and then aggregate them to obtain a (floating-point) global model. However, in some example embodiments, the FL aggregator may not de-quantize the local model parameters from all the UEs and continue with a quantized global model instead. For example, the aggregator may de-quantize only those local model parameter which have less digits than the local model parameter with the most number of digits, such that all the local model parameters have the most number of digits.

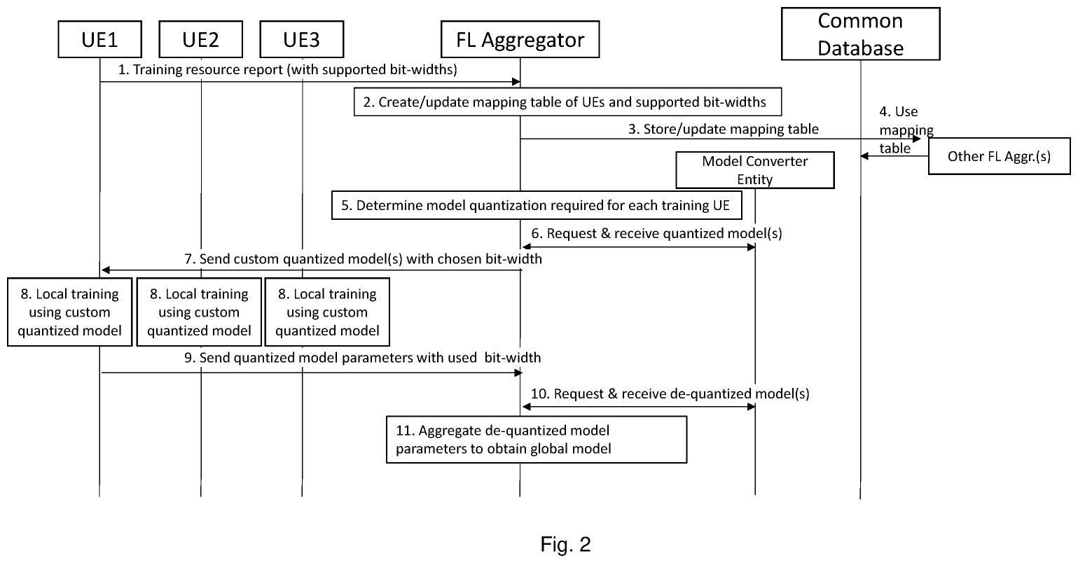

FIG. 2 illustrates a message sequence chart according to some example embodiments of the invention. IN detail, it illustrates one iteration (“loop”) of a federated learning process. The actions are as follows:

Action 1: The training UEs (UE1, UE2, and UE3 in FIG. 2, but the number of UEs is not limited to 3) provide an indication of their supported bit-width(s) (e.g., 8-bit, 16-bit, 32-bit, 64-bit) in the training resource report to the FL Aggregator. This indication may be in addition to other information such as link quality to the UE, power availability at the UE, etc. provided in the training resource report. The training resource report may be provided when the FL Aggregator requests for it or when there is any update to a previously reported information. In some example embodiments, the indication of the supported bit-width(s) may be provided separately from the training resource report, e.g. by a dedicated message.

TrainingResourceReport «dataType»: This Datatype represents the properties of TrainingResourceReport and may typically comprise the following attributes:
Each TrainingResourceReport is associated with a TrainingHostID that works as an identifier of the Local training instance/UE.
Each TrainingResourceReport specifies at least some of the supported training capabilities available at the Local training instance/UE. The training capabilities may include the supported bit-widths and may also include the supported environment to run local training. Supported environment may be a software operating environment that supports certain application types or a platform to run applications or even a python library with execution environment where models can be directly imported.

These attributes are depicted in the example of Table 1:

TABLE 1
Attributes of TrainingResourceReport (M = mandatory, O = optional; T = true; F = false)

| | Support | | | | |
|---|---|---|---|---|---|
| Attribute name | Qualifier | isReadable | isWritable | isInvariant | isNotifyable |
| TrainingHostID | M | T | F | F | F |
| SupportedBitWidths | M | T | F | F | F |
| SupportedEnvironment | O | T | F | F | T |

Action 2: The FL Aggregator maintains a mapping table of training UEs, where the bit-widths supported by the training UEs are mapped to the training UEs. Each training UE may also support multiple bit-widths. Table 2 is an example of such a mapping table. It includes additionally a validity duration indicating for how long the mapped supported bit-width(s) are valid (optional).

TABLE 2
Mapping table

| Training UEs | Supported bit-widths | Validity duration |
|---|---|---|
| UE1 | 8-bit precision, 16-bit | 60 minutes |
| | precision | |
| UE2 | 16-bit precision, 32-bit | 60 minutes |
| | precision | |
| UE3 | 32-bit precision | 60 minutes |

Actions 3 and 4: Optionally, the created mapping table in action 2 may be stored in a database (e.g. the ADRF so that other FL Aggregators (e.g., Application Functions) may use this information for their own FL use cases.

Action 5: Based on the mapping table created in action 2, the FL Aggregator decides on the custom model quantization (e.g., 16-bit precision for UE1 and UE2, 32-bit precision for UE3) to be applied on the (floating-point) aggregated model parameters (i.e., global model) for each training UE, to ensure that the training UEs can perform their local training and report local model parameters before the reporting deadline. Additionally, the choice of quantization decision may also be based on the power availability in the training UEs, storage memory available in the training UEs, Uu resource required for model parameters exchange, etc.

Actions 6 and 7: The FL Aggregator requests a model converter entity to provide quantized model(s) with the chosen precision value corresponding to each training UE as determined in action 5 and receives them from the model converter entity.

Action 8: The FL Aggregator sends the custom quantized global model to corresponding training UEs along with the details on the chosen precision value for quantization and the reporting deadline for sending local model parameters. In some example embodiments, the FL Aggregator may send quantized global models with different precision values to each training UE along with the information on their precision value.

An example to apply the message sequence chart of FIG. 2 is as follows: Suppose UE1 and UE2 have limited resources compared to U3. In this case, if FL Aggregator sends unquantized model to all three UEs, the local training performed by UE1 and UE2 will be slower (e.g., exceeding the reporting deadline) compared to UE3. To avoid this situation, the FL Aggregator sends 16-bit quantized model to UE1 and UE2 to perform ‘faster’ local training that will meet the reporting deadline. There could be number of ways on how the FL Aggregator determines the proper quantization to be used on a particular UE. The aggregator may use e.g. UE's power availability, computational resource availability, Uu resourceavailability etc.

An example option to determine the time needed for local retraining is for the FL Aggregator to send a dummy dataset to each of the UEs and ask them to perform local training using this dummy dataset and measure the model parameters reporting time from each UE. Based on this local training by the UEs, FL Aggregator may estimate the time needed for local retraining of the actual model.

CustomQuantizedModel «dataType»: This Datatype represents the properties of CustomQuantizedModel and may typically include the following attributes:
Each CustomQuantizedModel includes a QuantizedModelID specifying the Model data type instance
Each CustomQuantizedModel specifies the PrecisionValue (i.e., the bit-width) to which the model was quantized.
Each local training instance/UE may provide a QuantizedLocalTrainingReport to the FL Application function/Aggregator after local training is completed. Additionally, QuantizedLocalTrainingReport should be provided before a ReportingDeadline set by the FL Application function/Aggregator.

Table 3 shows an example of the attributes in CustomQuantizedModel.

TABLE 3
Attributes of CustomQuantizedModel (M = mandatory, O = optional; T = true; F = false)

| | Support | | | | |
|---|---|---|---|---|---|
| Attribute name | Qualifier | isReadable | isWritable | isInvariant | isNotifyable |
| QuantizedModelID | M | T | F | F | F |
| PrecisionValue | M | T | F | F | T |
| ReportingDeadline | O | T | T | F | T |

As an option, in some example embodiments, the FL Aggregator sends a list of custom quantized global model descriptors, along with location information from where the custom quantized global model my be downloaded, to each training UE, thus enabling them to download their preferred model in a particular iteration of FL training.

Action 9: The training UEs perform local training using the received custom quantized global model. If multiple versions/levels of quantized global models are received by a training UE, it may determine which is the best quantized global model to be used at that point in time for local training based on its dynamically changing characteristics and on the reporting deadline for sending local model parameters.

Action 10: The training UEs send the quantized local model parameters along with the information on the used precision value (if multiple versions/levels of quantized global models are received) to the FL Aggregator within their reporting deadline.

QuantizedLocalTrainingReport «dataType»: This Datatype represents the properties of QuantizedLocalTrainingReport and may typically comprise the following attributes:
Each QuantizedLocalTrainingReport includes a QuantizedModellD specifying the Quantized Model data type instance.
Each QuantizedLocalTrainingReport specifies the QuantizedModelParameters of the locally trained quantized model associated with the stated ModelID. As an option, the model instance associated with the stated ModelID may directly include the QuantizedModelParameters
Each QuantizedLocalTrainingReport specifies the PrecisionValue to which the locally trained quantized model was trained.

Table 4 shows an example of attributes of QuantizedLocalTrainingReport.

TABLE 4
Attributes of QuantizedLocalTrainingReport (M = mandatory, CM = conditionally mandatory, O =
optional; T = true; F = false)

| | Support | | | | |
|---|---|---|---|---|---|
| Attribute name | Qualifier | isReadable | isWritable | isInvariant | isNotifyable |
| ModellD | M | T | F | F | F |
| QuantizedModelParameters | CM | T | F | F | T |
| PrecisionValue | M | T | T | F | T |

Actions 11 and 12: Once the FL Aggregator receives quantized local model parameters from all training UEs along with the information on the used precision value, it may send these quantized local model parameters to the model converter entity to de-quantize them into floating-point precision. The de-quantized local model parameters from all training UEs are now sent back to the FL Aggregator.

Action 13: The FL Aggregator aggregates de-quantized local model parameters from all training UEs to obtain the global model to be used for next iteration of FL training.

In some example embodiments, the Aggregator may want a certain node to perform the local learning with a certain bit-width (and by the reporting deadline defined for all the participating nodes). When it turns out that the node cannot perform the local learning with the certain bit-width by the reporting deadline, the Aggregator may relax (i.e.: postpone) the reporting deadline such that all the participating nodes can perform their local training with the respective desired bit-width. For example, the Aggregator may instruct one or more of the other nodes to use a larger bit-width for the local learning, or may instruct one or more of the other nodes to perform more iterations of the local learning.

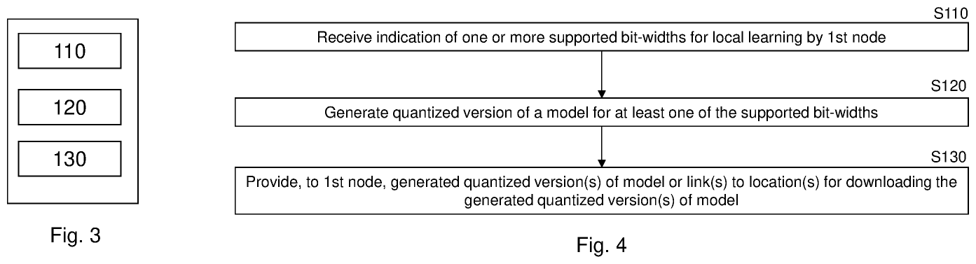

FIG. 3 shows an apparatus according to an example embodiment of the invention. The apparatus may be an aggregator (such as a gNB, a NWDAF, or a management function) or an element thereof. FIG. 4 shows a method according to an example embodiment of the invention. The apparatus according to FIG. 3 may perform the method of FIG. 4 but is not limited to this method. The method of FIG. 4 may be performed by the apparatus of FIG. 3 but is not limited to being performed by this apparatus.

The apparatus comprises means for receiving 110, means for generating 120, and means for providing 130. The means for receiving 110, means for generating 120, and means for providing 130 may be a receiving means, generating means, and providing means, respectively. The means for receiving 110, means for generating 120, and means for providing 130 may be a receiver, generator, and provider, respectively. The means for receiving 110, means for generating 120, and means for providing 130 may be a receiving processor, generating processor, and providing processor, respectively.

The means for receiving 110 receives an indication of one or more supported bit-widths for local learning by a first node among plural nodes (S110). The means for generating 120 generates a respective quantized version of a model for at least one of the supported bit-widths (S120). The means for providing 130 provides the generated quantized version of the model (i.e., the quantized version of the model for the one of the supported bit-widths) to the first node (S130). As another option, the means for providing 130 may provide to the first node a link to a location from where the first node may download the generated quantized version of the model (S130). The means for providing 130 may provide one or more generated quantized versions of the model (or one or more links to respective one or more locations from where the first node may download the one or more generated quantized versions of the model) to the first node. Thus, the first node may perform the local learning on the generated quantized version of the model.

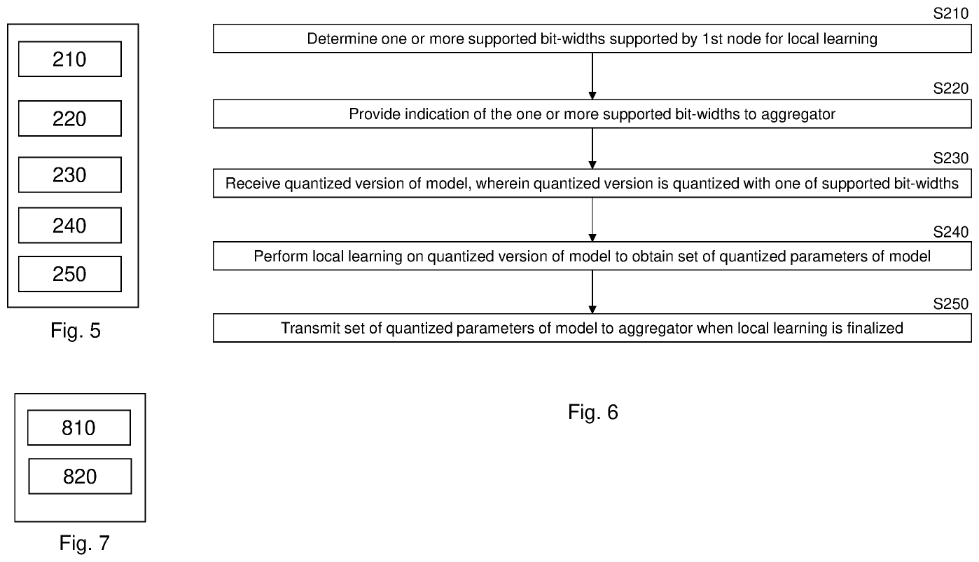

FIG. 5 shows an apparatus according to an example embodiment of the invention. The apparatus may be one of plural distributed nodes (such as a UE, or a NWDAF, or a management function) or an element thereof. FIG. 6 shows a method according to an example embodiment of the invention. The apparatus according to FIG. 5 may perform the method of FIG. 6 but is not limited to this method. The method of FIG. 6 may be performed by the apparatus of FIG. 5 but is not limited to being performed by this apparatus.

The apparatus comprises means for determining 210, means for providing 220, means for receiving 230, means for performing 240, and means for transmitting 250. The means for determining 210, means for providing 220, means for receiving 230, means for performing 240, and means for transmitting 250 may be a determining means, providing means, receiving means, performing means, and transmitting means, respectively. The means for determining 210, means for providing 220, means for receiving 230, means for performing 240, and means for transmitting 250 may be a determiner, provider, receiver, performer, and transmitter, respectively. The means for determining 210, means for providing 220, means for receiving 230, means for performing 240, and means for transmitting 250 may be a determining processor, providing processor, receiving processor, performing processor, and transmitting processor, respectively.

The means for determining 210 determines one or more supported bit-widths supported by a first node for local learning (S210). The means for providing 220 provides, to an aggregator, an indication of the one or more supported bit-widths determined in S210 (S220).

The means for receiving 230 receives a quantized version of a model (S230). The quantized version of the model is quantized with one of the supported bit-widths provided in S220. The means for performing 240 performs the local learning on the quantized version of the model (S240). Thus, the means for performing 240 obtains a set of quantized parameters of the model. The means for transmitting 250 transmits the set of quantized parameters of the model to the aggregator when the local learning is finalized (S250).

FIG. 7 shows an apparatus according to an example embodiment of the invention. The apparatus comprises at least one processor 810, at least one memory 820 including computer program code, and the at least one processor 810, with the at least one memory 820 and the computer program code, being arranged to cause the apparatus to at least perform at least the method according to at least one of FIGS. 4 and 6 and related description.

Some example embodiments are explained with respect to a 5G network. However, the invention is not limited to 5G. It may be used in other communication networks allowing FL by some of its members, too, e.g. in previous of forthcoming generations of 3GPP networks such as 4G, 6G, or 7G, etc. It may be used in non-3GPP mobile communication networks and wired communication networks, too. It may be used even outside from communication networks, e.g. in power grids.

Some example embodiments are explained with the UEs as the distributed nodes. For example, in such embodiments, a gNB or a dedicated network function may be the aggregator. However, the invention is not limited to this configuration. The invention may also be applied to other FL deployment options in mobile networks, such as: (i) Central NWDAF as FL Aggregator and distributed NWDAFs as distributed nodes; (ii) E2E service management domain as FL Aggregator and individual management domains as distributed nodes; and others.

One piece of information may be transmitted in one or plural messages from one entity to another entity. Each of these messages may comprise further (different) pieces of information.

Names of network elements, network functions, protocols, and methods are based on current standards. In other versions or other technologies, the names of these network elements and/or network functions and/or protocols and/or methods may be different, as long as they provide a corresponding functionality. The same applies correspondingly to the terminal.

If not otherwise stated or otherwise made clear from the context, the statement that two entities are different means that they perform different functions. It does not necessarily mean that they are based on different hardware. That is, each of the entities described in the present description may be based on a different hardware, or some or all of the entities may be based on the same hardware. It does not necessarily mean that they are based on different software. That is, each of the entities described in the present description may be based on different software, or some or all of the entities may be based on the same software. Each of the entities described in the present description may be deployed in the cloud.

According to the above description, it should thus be apparent that example embodiments of the present invention provide, for example, an aggregator (such as a gNB, a NWDAF, or a management function) or a component thereof, an apparatus embodying the same, a method for controlling and/or operating the same, and computer program(s) controlling and/or operating the same as well as mediums carrying such computer program(s) and forming computer program product(s). According to the above description, it should thus be apparent that example embodiments of the present invention provide, for example, a node (such as a UE, a NWDAF, or a management function) or a component thereof, an apparatus embodying the same, a method for controlling and/or operating the same, and computer program(s) controlling and/or operating the same as well as mediums carrying such computer program(s) and forming computer program product(s).

Implementations of any of the above described blocks, apparatuses, systems, techniques or methods include, as non-limiting examples, implementations as hardware, software, firmware, special purpose circuits or logic, general purpose hardware or controller or other computing devices, or some combination thereof. Each of the entities described in the present description may be embodied in the cloud.

It is to be understood that what is described above is what is presently considered the preferred example embodiments of the present invention. However, it should be noted that the description of the preferred example embodiments is given by way of example only and that various modifications may be made without departing from the scope of the invention as defined by the appended claims.

The phrase “at least one of A and B” comprises the options only A, only B, and both A and B. The terms “first X” and “second X” include the options that “first X” is the same as “second X” and that “first X” is different from “second X”, unless otherwise specified.

1. Apparatus comprising:
one or more processors and memory storing instructions that, when executed by the one or more processors, cause the apparatus to perform:
receiving an indication of one or more supported bit-widths for local learning by a first node among plural nodes;
generating a respective quantized version of a model for at least one of the supported bit- widths;
providing the generated respective quantized versions of the model for the at least one of the supported bit-widths or a link to location from where the first node may download the at least one quantized version of the model for the at least one of the supported bit-widths to the first node.

2. The apparatus according to claim 1, wherein the instructions, when executed by the one or more processors, further cause the apparatus to perform
selecting one of the one or more supported bit-widths for the first node;
instructing the first node to perform the local learning of the model using the selected supported bit-width, and wherein the instructions, when executed by the one or more processors, cause the apparatus to perform the generating such that the quantized version of the model for the selected supported bit-width is generated.

3. The apparatus according to claim 2, wherein the instructions, when executed by the one or more processors, cause the apparatus to perform the selecting such that the first node terminates the local learning of the model prior to a reporting deadline set for all of the plural nodes.

4. The apparatus according to claim 1, wherein more than one supported bit-widths are supported by the first node for the local learning; and
the instructions, when executed by the one or more processors, cause the apparatus to perform the generating such that a respective quantized version of the model is generated for plural supported bit-widths among the supported bit-widths, and
the providing such that the respective quantized versions of the model for the plural supported bit-widths among the supported bit-widths are provided to the first node.

5. The apparatus according to claim 2, wherein the instructions, when executed by the one or more processors, further cause the apparatus to perform
receiving a respective set of model parameters of the model from each of the plural nodes, wherein the parameters of the set of model parameters received from the first node is quantized for the selected one of the supported bit-width;
dequantizing the parameters of the set of model parameters received from the first node;
aggregating the set of the model parameters of the model received from the plural nodes to obtain an aggregated model, wherein the dequantized parameters are aggregated for the first node.

6. The apparatus according to claim 1, wherein the instructions, when executed by the one or more processors, further cause the apparatus to perform
requesting the indication of the one or more supported bit-widths from the first node; wherein
the receiving the indication of the one or more supported bit-widths comprises receiving the indication of the one or more supported bit-widths from the first node in response to the requesting.

7. The apparatus according to claim 1, wherein the instructions, when executed by the one or more processors, further cause the apparatus to perform
requesting the indication of the one or more supported bit-widths from a database; wherein
the receiving the indication of the one or more supported bit-widths comprises receiving the indication of the one or more supported bit-widths from the database in response to the requesting.

8. The apparatus according to claim 1, wherein the instructions, when executed by the one or more processors, cause the apparatus to perform, for each of the plural nodes:
the receiving the indication of the respective one or more bit-widths for local learning of the model supported by the respective node,
the generating the respective quantized versions of the model for the at least one of the respective one or more bit-widths supported by the respective node, and
the providing, to the respective node, the respective quantized versions of the model for the at least one of the respective one or more bit-widths supported by the respective node or the link to the location for the respective node from where the respective node may download the respective quantized versions of the model for the at least one of the bit-widths supported by the respective node.

9. The apparatus according to claim 1, wherein one of the following:
a base station comprises the apparatus, and each of the plural nodes is comprised by a respective terminal;
a central network data analytics function comprises the apparatus, and each of the plural nodes is comprised by a respective distributed network data analytics function;
an application function comprises the apparatus, and each of the plural nodes is comprised by a respective terminal; and
a management function in an end-to-end service management domain comprises the apparatus, and each of the plural nodes is comprised by a management function in a respective individual management domain.

10. The apparatus according to claim 2, wherein the instructions when executed by the one or more processors, cause the apparatus to perform further:
determining a calculation time for the selected one of the supported bit-widths;
checking whether the calculation time elapses prior to a first reporting deadline defined for all of the plural nodes;
determining a second reporting deadline if the calculation time elapses prior to the first reporting deadline;
applying the second reporting deadline to all of the plural nodes; wherein
the calculation time for the one of the supported bit-widths indicates how long the first node needs for the local learning of the model quantized with the selected one of the supported bit-widths;
the second reporting deadline is determined such that the calculation time for the one of the supported bit-widths does not elapse prior to the second reporting deadline.

11. The apparatus according to claim 10, wherein the instructions when executed by the one or more processors, cause the apparatus to perform:
the applying the second reporting deadline such that for at least one second node of the plural nodes different from the first node a larger one of the bit-widths supported by the second node than the supported bit-width selected for the first reporting deadline is selected; and/or
the applying such that a number of iterations in the local learning of the second node for the second reporting deadline is larger than a number of iterations in the local learning of the second node for the first reporting deadline.

12. Apparatus comprising:
one or more processors, and memory storing instructions that, when executed by the one or more processors, cause the apparatus to perform:
determining one or more supported bit-widths supported by a first node for local learning;
providing, to an aggregator, an indication of the one or more supported bit-widths;
receiving a quantized version of a model, wherein the quantized version of the model is quantized with one of the supported bit-widths;
performing the local learning on the quantized version of the model to obtain a set of quantized parameters of the model;
transmitting the set of quantized parameters of the model to the aggregator when the local learning is finalized.

13. The apparatus according to claim 12, wherein the instructions, when executed by the one or more processors, further cause the apparatus to perform monitoring whether a request for the indication of the one or more supported bit-widths is received or whether the supported bit-widths have changed;
inhibiting the providing the indication of the one or more bit-widths if the request for the indication of the one or more supported bit-widths is not received and, according to the monitoring, the supported bit-widths have not changed.

14. The apparatus according to claim 12, wherein the instructions, when executed by the one or more processors, cause the apparatus to perform the receiving the quantized version of the model by receiving a link to a location and downloading the quantized model from the location.

15. The apparatus according to claim 12, wherein
more than one supported bit-widths are supported by the first node for the local learning; and the instructions, when executed by the one or more processors, further cause the apparatus to perform
receiving a respective quantized version of the model for plural ones of the supported bit-widths;
selecting one of the plural supported bit-widths for which a respective quantized version of the model is received;
inhibiting the performing the local learning on the respective quantized versions of the models for the supported bit-widths different from the selected supported bit-width.

16. The apparatus according to claim 15, wherein the instructions, when executed by the one or more processors, further cause the apparatus to perform
receiving, from the aggregator, a reporting deadline; and the instructions, when executed by the one or more processors, cause the apparatus to perform
the selecting such that the performing the local learning on the respective quantized version of the model for the selected one of the one or more supported bit-widths is finalized before the reporting deadline.

17-34. (canceled)
